(19) United States
(12) Patent Application Publication
(10) Pub. No.: US 2006/0154823 A1
(43) Pub. Date: Jul. 13, 2006

(54) Synergistically acting herbicidal mixtures

(75) Inventors: Matthias Witschel, Bad Durkheim (DE); Cyrill Zagar, Mannheim (DE); Andreas Landes, Romerberg-Heiligenstein (DE); Peter Dombo, Wiesbaden (DE)

Correspondence Address: ROTHWELL, FIGG, ERNST & MANBECK, P.C., 1425 K STREET, N.W., SUITE 800, WASHINGTON, DC, 20005, US

(73) Assignee: BASF AKTIENGESELLSCHAFT, Ludwigshafen (DE)

(21) Appl. No.: 10/548,740

(22) PCT Filed: Mar. 5, 2004
(86) PCT No.: PCT/EP04/02240

§ 371 Date: Sep. 13, 2005

Related U.S. Application Data
(60) Provisional application No. 60/453,958, filed on Mar. 13, 2003.

(51) Int. Cl. A01N 43/60

(52) U.S. Cl. 504/136

(57) ABSTRACT

A synergistic herbicidal mixture comprising: A) [N-(5,7-Dimethoxy[1,2,4]triazolo[1,5-a]pyrimidin-2-yl)-2-methoxy-4-(trifluoromethyl)]-3-pyridinesulfonamnid (I) or one of its environmentally compatible salts; B) and at least one herbicidal compound from the group of alloxydim, clethodim, cloproxydim, cycloxydim, butroxydim, clefoxydim, tepraloxydim, cyhalofop-butyl, fenthiapropethyl, fluazifop-P-butyl, isoxapyrifop, propaquizafop, quizalofop-ethyl, quizalofop-P-ethyl quizalofop-tefuryl, flamprop-methyl, flamprop-isopropyl, imazapyr, imazapic, pyrithiobac-acid, pyrithiobac-sodium, bispyribac-sodium, KIH-6127, pyribenzoxym, metosulam, azimsulfuron, bensulfuron-methyl, chlorsulfuron, cinosulfuron, cyclosulfamuron, ethoxysulfuron, flazasulfuron, halosulfuron-methyl, imazosulfuron, primisulfuron-methyl, pyrazosulffuron-ethyl, rirmsulfuron, sulfometuron-methyl, triflusulfuron-methyl, mesosulfuron, iodosulfuron, allidochlor (CDAA), benzoylprop-ethyl, bromobutide, chlorthiamid, diphenamid, etobenzanid (benzchlomet), fluthiamide, fosamin, monalide, picloram, benazolin, naptalame, diflufenzopyr, fluorochloridone, fluridone, flurtamone, norflurazon, amitrol, sulfosate, bilanafos (bialaphos), anilofos, mefenacet, dimethenamid, S-dimethenamid, alachlor, butachlor, butenachlor, diethatyl-ethyl, dimethachlor, metazachlor, pretilachlor, propachlor, prynachlor, terbuchlor, thenylchlor, xylachlor, butylate, cycloate, di-allate, dimepiperate, EPTC, esprocarb, molinate, pebulate, prosulfocarb, thiobencarb (benthiocarb), tri-allate, vernolate, benfuresate, perfluidone, asulam, carbetamid, chlorpropham, orbencarb, pronamid (propyzamid), propham, tiocarbazil, butralin, dinitramin, ethalfluralin, fluchloralin, oryzalin, prodiamine, dithiopyr thiazopyr, butamifos, chlorthal-dimethyl (DCPA), maleic hydrazide, aclonifen, bifenox, chlornitrofen (CNP), ethoxyfen, fluorodifen, fluoroglycofen-ethyl, fomesafen, furyloxyfen, nitrofen, nitrofluorfen, oxyfluorfen, oxadiargyl, oxadiazon, azafenidin, butafenacil, flumiclorac-pentyl, flumioxazin, flumipropyn, flupropacil, fluthiacet-methyl, sulfentrazone, thidiazimin, ET-751, JV 485, nipyraclofen, propanil, pyridate, pyridafol, bromofenoxim, dinoseb, dinoseb-acetate, dinoterb DNOC, cyperquat-chloride, difenzoquat-methylsulfate, diquat, paraquat-dichloride, chlorbromuron, chlorotoluron, difenoxuron, dimefuron, diuron, ethidimuron, fenuron, isoproturon, isouron, methabenzthiazuron, methazole, metobenzuron, metoxuron, neburon, siduron, tebuthiuron, ioxynil, chloridazon, ametryn, atrazine, cyanazine, desmetryn, dimethamethryn, hexazinone, prometon, prometryn, propazine, simazine, simetryn, terbumeton, terbutryn, terbutylazine, trietazine, metamitron, bromacil, lenacil, terbacil, desmedipham, phenmedipham, tridiphane, 2,4-DB, clomeprop, MCPB, triclopyr, chloramben, quinclorac dichlobenil, dalapon, ethofurnesate, chlorfenac (fenac), aziprotryn, barban, bensulide, benzthiazuron, benzo-fluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid, trimeturon, 8-(2,6-Diethyl-4-methylphenyl)-1,2,4,5-tetrahydro-9-hydroxy-7H-pyrazolo[1,2-d][1,4,5]oxadiazepin-7-one, pivalicacid-[8-(2,6-di-ethyl;methylphenyl)-1,2,4,5-tetrahydro-7-oxo-7H-pyrazolo[1,2-d][1,4,5]oxadiazepin-9-yl]ester or their

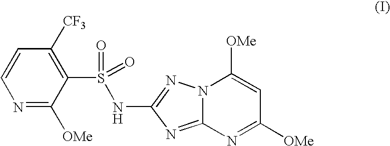

The present invention relates to a synergistic herbicidal mixture comprising
A) [N-(5,7-Dimethoxy[1,2,4]triazolo[1,5-a]pyrimidin-2-yl)-2-methoxy-4-(trifluoromethyl)]-3-pyridinesulfonamid I 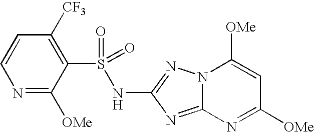
   or one of its environmentally compatible salts;
B) and at least one herbicidal compound from the group of alloxydim, clethodim, cloproxydim, cycloxydim, butroxydim, clefoxydim, tepraloxydim, cyhalofop-butyl, fenthiapropethyl, fluazifop-P-butyl, isoxapyrifop, propaquizafop, quizalofop-ethyl, quizalofop-P-ethyl, quizalofop-tefuryl, flamprop-methyl, flamprop-isopropyl, imazapyr, imazapic, pyrithiobac-acid, pyrithiobac-sodium, bispyribac-sodium, KIH-6127, pyribenzoxym, metosulam, azimsulfuron, bensulfuron-methyl, chlorsulfuron, cinosulfuron, cyclosulfamuron,ethoxysulfuron, flazasulfuron, halosulfuronmethyl, imazosulfuron, primisulfuron-methyl, pyrazosulfuron-ethyl, rimsulfuron, sulfometuron-methyl, triflusulfuron-methyl, mesosulfuron, iodosulfuron, allidochlor (CDM), benzoylprop-ethyl, bromobutide, chlorthiamid, diphenamid, etobenzanid (benzchlomet), fluthiamide, fosamin, monalide, picloram, benazolin, naptalame, diflufenzopyr, fluorochloridone, fluridone, flurtamone, norflurazon, amitrol, sulfosate, bilanafos (bialaphos), anilofos, mefenacet, dimethenamid, S-dimethenamid, alachlor, butachlor, butenachlor, diethatyl-ethyl, dimethachlor, metazachlor, pretilachlor, propachlor, prynachlor, terbuchlor, thenylchlor, xylachlor, butylate, cycloate, di-allate, dimepiperate, EPTC, esprocarb, molinate, pebulate, prosulfocarb, thiobencarb (benthiocarb), tri-allate, vemolate, benfuresate, perfluidone, asulam, carbetamid, chlorpropham, orbencarb, pronamid (propyzamid), propham, tiocarbazil, butralin, dinitramin, ethalfluralin, fluchloralin, oryzalin, prodiamine, dithiopyr thiazopyr, butamifos, chlorthal-dimethyl (DCPA), maleic hydrazide, aclonifen, bifenox, chlomitrofen (CNP), ethoxyfen, fluorodifen, fluoroglycofen-ethyl, fomesafen, furyloxyfen, nitrofen, nitrofluorfen, oxyfluorfen, oxadiargyl, oxadiazon, azafenidin, butafenacil, flumiclorac-pentyl, flumioxazin, flumipropyn, flupropacil, fluthiacet-methyl, sulfentrazone, thidiazimin, ET-751, JV 485, nipyraclofen, propanil, pyridate, pyridafol, bromofenoxim, dinoseb, dinoseb-acetate, dinoterb,DNOC, cyperquat-chloride, difenzoquat-methylsulfate, diquat, paraquatdichloride, chlorbromuron, chlorotoluron, d-enoxuron, dimefuron, diuron, ethidimuron, fenuron, isoproturon, isouron, methabenzthiazuron, methazole, metobenzuron, metoxuron, neburon, siduron, tebuthiuron, ioxynil, chloridazon, ametryn, atrazine, cyanazine, desmetryn, dimethamethryn, hexazinone, prometon, prometryn, propazine, simazine, simetryn, terbumeton, terbutryn, terbutylazine, trietazine, metamitron, bromacil, lenacil, terbacil, desmedipham, phenmedipham, tridiphane, 2,4-DB, clomeprop, MCPB, triclopyr, chloramben, quinclorac dichlobenil, dalapon, ethofumesate, chlorfenac (fenac), aziprotryn, barban, bensulide, benzthiazuron, benzo-fluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid,trimeturon, 8-(2,6Diethyl-4-methylphenyl)-1,2,4,5-tetrahydro-9-hydroxy-7H-pyrazolo[1,2-d][1,4,5]oxadiazepin-7-one, pivalicacid-[8-(2,6diethyl-4-methylphenyl)-1,2,4,5-tetrahydro-7-oxo-7H-pyrazolo[1,2-d][1,4,5]oxadiazepin-9-yl]ester
   or their environmentally compatible salts.
and, if desired,
C) at least one compound from the group of the safeners Dichlormid, Benoxacor, LAB-145138, MG-191, MON-13900, Cyometrinil, Oxabetrinil, Fluxofenim, Flurazole, Naphtalicacidanhydride, Fenchlorim, Fenchlorazol, Mefenpyr and its environmentally compatible salts and esters, Isoxadifen and its environmentally compatible salts and esters, Cloquintocet and its environmentally compatible salts, esters and hydrates, 1-Ethyl-4-hydroxy-3-(1H-tetrazol-5-yl)-1H-quinolin-2-one, 4-Carboxymethyl-chroman-4-carboxylic acid, N-(2-Methoxy-benzoyl)-4-(3-methyl-ureido)-benzenesulfonamide, (3-Oxo-isothiochroman-4-ylidenemethoxy)-acetic acid methyl ester.

The invention furthermore relates to herbicidal compositions comprising a herbicidally active amount of a synergistic herbicidal mixture as defined above and at least one liquid and/or solid carrier and, if desired, at least one surfactant.

Moreover, the invention relates to a process for the preparation of these compositions and to a method of controlling undesirable vegetation.

In crop protection products, it is always desirable to increase the specific activity of an active ingredient and the reliability of action. It is an object of the present invention to increase the activity and/or selectivity of the compound according to formula I and its environmentally compatible salts against undesirable harmful plants.

We have found that this object is achieved by the mixtures defined at the outset. We have furthermore found herbicidal compositions which comprise these mixtures, processes for their preparation, and methods of controlling undesirable vegetation. In the last-mentioned cases, it is irrelevant whether the herbicidally active compounds of the components A),B) and, if desired, C) are formulated and applied jointly or separately and in which sequence they are applied in the case of separate application.

The mixtures according to the invention show a synergistic effect; the compatibility of the herbicidally active compounds of components A),B) and, if desired C) for certain crop plants is generally retained.

The compound of the formula I is disclosed in WO 02/36595. Mixtures with other herbicides are disclosed in Research Disclosure, July 2002, Number 459, No 459085.

The above mentioned compounds B) and/or C) are described, for example, in
“Herbizide [Herbicides]”, Hock, Fedtke, Schmidt, 1st edition, Thieme 1995 (s. “quinclorac” p. 238, “molinat” p. 32, “butachloe” p. 32, “pretilachlor” p. 32, “dithiopyr” p. 32, “mefenacet” p. 32, “dimepiperate” p. 32, “bensulfuronmethyl” p. 31, “pyrazosulfuron-ethyl” p. 31, “cinosulfuron” p. 31, “benfuresate” p. 233, “bromobutide” p. 243, “dymron” p. 243, “dimethyametryn” p. 118, “esprocarb” p. 229, “pyributicarb” p. 32, “cinemthylin” p. 32, “propanil” p. 32, “azimsulfuron (DPX-A-8947)” p. 175, “chlorpropham” p. 205, “ethoxyfen” p. 30, “flumiclorac-pentyl” p. 35, “flupropacil” p. 143, “nipyraclofen” p. 145, “metosulam” p. 33, “ethamet-sulfuron-methyl” p. 36, “pyrithiobac acid” p. 181);
“Agricultural Chemicals”, Book II Herbicides, 1993 (s. “thiobencarb” p. 85, “napropanilid” p. 49, “piperophos” p. 102, “anilofos” p. 241, “imazosulfuron (TH-913)” p. 150, “etobenzamid (HW-52)” p. 54, “poast” p. 253, “focus” p. 222, “dimethenamid” p. 48, “sulfosate” p. 236, “2,4-DB” p. 10, “—P” p. 6, “flupoxam” p. 44, “prosulfocarb” p. 84, “metazachlor” p. 64, “flurtamone” p. 265, “bromofenoxim” p. 228, “omesafen” p. 248, “fluazifop-P-butyl” p. 207, “quizalofop-P-ethyl” p. 210, “quizalofop-terfuryl” p. 211, “flumioxazin” p. 43, “flumipropyn” p. 267, “sulfentrazone” p. 261, “thiazopyr” p. 226, “pyrithiobac-sodium” p. 266, “halosulfuronmethyl” p. 148, “rimsulfuron” p. 138, “triflusul-furon-methyl” p. 137, “primisulfuronmethyl” p. 147);
“Agricultural Chemicals”, Book II Herbicides, 13^{th} Edition (s. “carfenstole” p. 284, “ethoxy-sulfuron” p. 149, “pyribenzoxym” p. 279, “diflufenzopyr” p. 90, “ET-751” p. 278, “fluthiacet-methyl” p. 277, “imazapic” p. 160, “butenachlor” p. 54, “tiocarbazil” p. 84, “fluthiamide” p. 62, “butroxydim” p. 259,)
“Short Review of Herbicides & PGRs 1991, Hodogaya Chemicals (s. “furyloxyfen” p. 142, “triazofenamid” p. 268, “thenylchlorid (NSK-850)” p. 52, “cumyluron (JC-940)” p. 90, “(AC-92553)” p. 58, “buthidazole” p. 88, “cyprazole” p. 38, “allidochlor” p. 48, “benzoylprop-ethyl” p. 38, “chlorthiamid” p. 150, “diphenamid” p. 34, “flamprop-methyl” p. 40, “fosamin” p. 232, “monalide” p. 32, “naptalam” p. 36, “pronamid” p. 34; “bialaphos” p. 234, “amitrol” p. 254, “clomeprop p. 20,”” p. 6, “fenoprop” p. 8, “MCPB” p. 8, “napropamide” p. 1.6, “triclopyr” p. 154, “chloramben” p. 28, “fluorochloridone” p. 266, “fluridone” p. 156, “asulam” p. 112, “barban” p. 100, “butylate” p. 106, “carbetamide” p. 36, “chlorobufam” p. 100, “cycloate” p. 108, “desmedipham” p. 104, “di-allate” p. 106, “EPTC” p. 108, “orbencarb” p. 112, “pebulate” p. 106, “phen-isopham” p. 118, “phenmedipham” p. 104, “propham” p. 100, “sulfallate” p. 110, “terbucarb” p. 102, “tri-allate” p. 108, “vemolate” p. 108, “alachlor” p. 46, “diethathyl-ethyl” p.48, “dimethachlor” p. 50, “propachlor” p. 44, “pymachlor” p. 44, “terbuchlor” p. 48, “xylachlor” p. 52, “alloxydim” p. 260, “clethodim” p. 270, “cloproxydim” p. 268, “dalapon” p. 212, “ethofumesate” p. 124, “butralin” p. 58, “dinitramin” p. 56, “ethalfluralin” p. 60, “fluchloralin” p. 54, “isopropalin” p. 58, “nitralin” p. 58, “oryzalin” p. 60, “prodiamine” p. 62, “profluralin” p. 54, “dinoseb” p. 128, “dinoseb-acetate” p. 128, “dinoterb” p. 128, “DNOC” p. 126, “aclonifen” p. 146, “bifenox” p. 140, “chlomitrofen” p. 138, “difenoxuron” p. 76, “fluorodifen” p. 138, “fluoroglycofen-ethyl” p. 146, “nitrofen” p. 136, “nitrofluorfen” p. 140, “oxyfluorfen” p. 140, “cyperquat-chloride” p. 158, “difenzoquat-methylsulfate” p. 160, “diquat” p. 158, “paraquat-dichloride” p. 158, “benzthi-azuron” p. 82, “buturon” p. 66, “chlorbromuron” p. 72, “chloroxuron” p. 76, “chlorotoluron” p. 74, “cycluron” p. 84, “dimefuron” p. 88, “diuron” p. 70, “ethidimuron” p. 86, “fenuron” p. 64, “isoproturon” p. 80, “isouron” p. 88, “karbutilate” p. 76, “methabenzthiazuron” p. 82, “metoxuron” p. 72, “monuron” p. 64, “neburon” p. 72, “siduron” p. 68, “tebuthiuron” p. 86, “trimeturon” p. 64, “isocarbamid” p. 168, “imazapyr” p. 170, “imazaquin” p. 170, “methazole” p. 162, “oxadiazon” p. 162, “tridiphane” p. 266, “ioxynil” p. 148, “fenthiaprop-ethyl” p. 20, “isoxapyrifop” p. 22, “propaquizafop” p. 24, “quizalo-fop-ethyl” p. 20, “chlorfenac” p. 258, “chlorfenprop-methyl” p. 258, “chloridazon” p. 174, “maleic hydrazide” p. 162, “norflurazon” p. 174, “pyridate” p. 176, “picloram” p. 154, “chlorsulfuron” p. 92, “flazasulfuron” p. 96, “sulfometuron-methyl” p. 92, “tria-sulfuron” p. 94, “ametryn” p. 198, “atrazine” p. 188, “aziprotryne” p. 206, “cyanazine” p. 192, “cyprazine” p. 192, “desmetryne” p. 200, “dipropetryn” p. 202, “eglinazine-ethyl” p. 208, “hexazinone” p. 208, “procyazine” p. 192, “prometone” p. 196, “prometryn” p. 196, “propazine” p. 188, “secbumeton” p. 196, “simazine” p. 188, “simetryn” p. 196, “terbumeton” p. 204, “terbutryn” p. 198, “terbutylazine” p. 190, “trietazine” p. 188, “ethiozine” p. 210, “metamitron” p. 206, “bromacil” p. 180, “lenacil” p. 180, “terbacil” p. 180, “benazolin” p. 262, “bensulide” p. 228, “benzofluor” p. 266, “butamifos” p. 228, “DCPA” p. 28, “dichlobenil” p. 148, “endothal” p. 264, “mefluidide” p. 306, “perfluidone” p. 260, “erbuchlor” p. 48);
“Global Herbicide Directory” First Edition, 1994 (s. “oxadi-argyl” p. 96);
“European Directory of Agrochemical Products” Volume 2—Herbicides” Fourth Edition, (s. “buminafos” p. 255).
“The Pesticide Maunal,12^{th} edition, 2000 (s. “bispyribac-sodium” p. 97, “cyclosulfamuron” p. 217, “pretiachlor” p. 755)
“Herbizide [Herbicides]”, Hock, Fedtke, Schmidt, 1st edition, Thieme 1995 (s. “Dichlormid” p. 263, “Benoxacor” p. 263, “LAB-145138” p. 263, “MG-191” p. 263, “MON-13900” p. 263, “Cyometrinil” p. 265, “Oxabetrinil” p. 265, “Fluxofenim” p. 265, “Flurazole” p. 265, “Naphtalicacidanhydride” p. 265, “Fenchlorim” p. 266, “Fenchlorazol” p. 266, Isoxadifen, “Cloquintocet” p. 266.

Moreover, the compound “DEH-112” is disclosed in European Patent Application EP-A 302 203. The compound “tepraloxydim” is described in DE-A 33 36 140; the compound “fluorbentranil” in EP-A 84 893. Other compounds are known from “Brighton Crop Protection Conference—Weeds—1993” (S. “thidiazimin” p. 29, “AC-322140” p. 41, “KIH-6127” p. 47, “KIH-2023” p. 61, “metobenz-uron” p. 67). The compound “carfenstrole (CH-900)” is mentioned in EP-A 332 133. The compounds 1-Ethyl4-hydroxy-3-(1H-tetrazol-5-yl)-1H-quinolin-2-one, 4-Carboxymethyl-chroman-4-carboxylic acid, N-(2-Methoxy-benzoyl)-4-(3-methyl-ureido)-benzenesulfonamide, (3-Oxo-isothiochroman-4-ylidenemethoxy)-acetic acid methyl ester are described e.g. in WO02/087322. “Mesosulfurone” is described in e.g. Phytoma (2002), 550, p. 52-54.

The compound of the formula I and/or the herbicidally active compounds and safeners from amongs groups B) and/or C) may also exist in the form of their environmentally compatible salts. Such salts are, in general, the salts of those cations, or the acid addition salts of those acids, whose cations, or anions, respectively, do not adversely affect the herbicidal action of the active ingredients.

Suitable cations are, in particular, ions of the alkali metals, preferably lithium, sodium and potassium, of the alkaline earth metals, preferably calcium and magnesium, and of the transition metals, preferably manganese, copper, zinc and iron, and also ammonium, it being possible in this case, if desired, for one to four hydrogen atoms to be replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, isopropylammonium, dimethylammonium, diisopropylammonium, tetramethylammonium, tetrabutylammonium, 2-(2-hydroxyeth-1-oxy)eth-1-yl ammonium, di(2-hydroxyeth-1-yl)ammonium, trimethylbenzylammonium, furthermore phosphonium ions, sulfonium ions, preferably tri(C₁-C₄-alkyl)sulfonium and sulfoxonium ions, preferably, tri(C₁-C₄-alkyl)sulfoxonium.

Anions of suitable acid addition salts are mainly chloride, bromide, fluoride, hydrogen sulfate, sulfate, dihydrogen phosphate, hydrogen phosphate, nitrate, hydrogen carbonate, carbonate, hexafluorosilicate, hexafluorophosphate, benzoate and the anions of C₁-C₄-alkanoic acids, preferably formate, acetate, propionate and butyrate.

Preferred herbicidal mixtures according to the invention are mixtures comprising component A) and
B) at least one herbicidal compound from the group of cycloxydim, tepraloxydim, cyhalofop-butyl, fluazifop-P-butyl, flamprop-methyl, flamprop-isopropyl, imazapyr, imazapic, pyrithiobac-sodium, bispyribac-sodium, metosulam, bensulfuronmethyl, chlorsulfuron, cinosulfuron, cyclosulfamuron, ethoxysulfuron, halosulfuron-methyl, pyrazosulfuron-ethyl, rimsulfuron, sulfometuron-methyl, triflusulfuronmethyl, mesosulfuron, iodosulfuron, bromobutide, chlorthiamid, picloram, diflufenzopyr, fluorochloridone, sulfosate, mefenacet, dimethenamid, S-dimethenamid, alachlor, butachlor, metazachlor, pretilachlor, tri-allate, butralin, oryzalin, dithiopyr, thiazopyr, aclonifen, bifenox, fluoroglycofen-ethyl, oxadiargyl, oxadiazon, azafenidin, butafenacil, flumiclorac-pentyl, flumioxazin, fluthiacetmethyl, sulfentrazone, thidiazimin, ET-751, JV 485, nipyraclofen, propanil, pyridate, pyridafol, paraquat-dichloride, chlorbromuron, chlorotoluron, diuron, isoproturon, siduron, ioxynil, chloridazon, ametryn, atrazine, cyanazine, prometryn, simazine, terbutylazine, metamitron, bromacil, 2,4-DB, clomeprop, MCPB, triclopyr, chloramben, quinclorac dichlobenil, cafenstrole, cinmethylin, flucabazone, flupoxam, monuron, oxaciclomefone, triaziflam, triazofenamid,trimeturon, 8-(2,6-Diethyl-4-methylphenyl)-1,2,4,5-tetrahydro-9-hydroxy-7H-pyrazolo[1,2-d][1,4,5]oxadiazepin-7-one, pivalicacid-[8-(2,6-diethyl methylphenyl)-1,2,4,5-tetrahydro-7-oxo-7H-pyrazolo[1,2-d][1,4,5]oxadiazepin-9-yl]ester
   or their environmentally compatible salts.
and, if desired,
C) at least one compound from the group of the safeners Dichlormid, Benoxacor, LAB-145138, MG-191, MON-13900, Naphtalicacidanhydride, Fenchlorim, Fenchlorazol, Mefenpyr and its environmentally compatible esters, Isoxadifen and its environmentally compatible esters, Cloquintocet and its environmentally compatible esters and hydrates, in particular Cloquintocetmexyl.

Particular preferred herbicidal mixtures according to the invention are mixtures comprising component A) and
B) at least one herbicidal compound from the group of cycloxydim, tepraloxydim, flamprop-methyl, imazapyr, imazapic, metosulam, bensulfuron-methyl, chlorsulfuron, cyclosulfamuron, ethoxysulfuron, halosulfuron-methyl, rimsulfuron, sulfometuron-methyl, mesosulfuron, iodosuifuron, picloram, diflufenzopyr, fluorochloridone, sulfosate, dimethenamid, S-dimethenamid, alachlor, butachlor, metazachlor, pretilachlor, tri-allate, aclonifen, bifenox, fluoroglycofen-ethyl, butafenacil, propanil, pyridate, paraquat-dichloride, chlorbromuron, chlortoluron, diuron, isoproturon, atrazine, cyanazine, simazine, 2,4-DB, quinclorac, dichlobenil, cinmethylin, flucabazone, flupoxam, 8-(2,6-Diethyl-4-methylphenyl)-1,2,4,5-tetrahydro-9-hydroxy-7H-pyrazolo[1,2-d][1,4,5]oxadiazepin-7-one, pivalicacid-[8-(2,6-diethyl-4-methylphenyl)-1,2,4,5-tetrahydro-7-oxo-7H-pyrazolo[1,2-d][1,4,5]oxadiazepin-9-yl]ester
   or their environmentally compatible salts,
and, if desired,
C) at least one compound from the group of the safeners Dichlormid, Benoxacor, LAB-145138, MG-191, MON-13900, Naphtalicacidanhydride, Fenchlorim, Fenchlorazol, Mefenpyr and its environmentally compatible esters, lsoxadifen and its environmentally compatible esters, Cloquintocet and its environmentally compatible esters and hydrates, in particular Cloquintocetmexyl.

Very particular preferred herbicidal mixtures according to the invention are mixtures comprising component A) and
B) at least one herbicidal compound from the group of cycloxydim, tepraloxydim, flamprop-methyl, imazapyr, imazapic, metosulam, mesosulfuron, iodosulfuron, diflufenzopyr, sulfosate, dimethenamid, S-dimethenamid, metazachlor, tri-allate, paraquat-dichloride, isoproturon, atrazine, cyanazine, 2,4DB, quinclorac
   or their environmentally compatible sals,
and, if desired,
C) at least one compound from the group of the safeners Benoxacor, Mefenpyr and its environmentally compatible esters, Isoxadifen and its environmentally compatible esters, Cloquintocet and its environmentally compatible esters and hydrates, in particular Cloquintocetmexyl.

In a further particular embodiment, the synergistic herbicidal mixture comprises component A) with
B) at least one herbicidal compound from the group of imazapyr, imazapic,
and, if desired,
C) Cloquintocet and its environmentally compatible esters and hydrates, in particular Cloquintocetmexyl

In a further particular embodiment, the synergistic herbicidal mixture comprises component A) with
B) iodosulfuron,
and, if desired,
C) at least one compound from the group of the safeners Isoxadifen and its environmentally compatible esters, Cloquintocet and its environmentally compatible esters and hydrates, in particular Cloquintocetmexyl.

For particular preferred embodiments, the respective preferences described above apply analogously.

The present invention also extends to herbicidal compositions which comprise a herbicidally active amount of a synergistic herbicidal mixture (comprising components A), B) and, if desired, C) as described above), at least one liquid and/or solid carrier and, if desired, at least one surfactant.

The herbicidal compositions and synergistic herbicidal mixtures according to the invention can effect very good control of broad-leaved weeds and grass weeds in crops such as maize, cereals, rice, canola, sunflower and soya without damaging the crop plants, an effect observed especially even at low rates of application.

Taking into consideration the variety of application method in question, the herbicidal compositions and synergistic herbicidal mixtures according to the invention can additionally be employed in a further number of crop plants for eliminating undesirable plants. Examples of suitable crops are the following:

Allium cepa, Ananas comosus, Arachis hypogaea, Asparagus officinalis, Beta vulgaris ssp. altissima, Beta vulgaris ssp. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, lpomoea batatas, Juglans regia, Lens culinaris, Linum usitatissimum, Lycopersicon lycopersicum, Malus spp., Manihot esculenta, Medicago sativa, Musa spp., Nicotiana tabacum (N.rustica), Olea europaea, Oryza sativa, Phaseolus lunatus, Phaseolus vulgaris, Picea abies, Pinus spp., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera und Zea mays.

Moreover, the herbicidal compositions and synergistic herbicidal mixtures according to the invention can also be used in crops which tolerate the action of herbicides due to breeding, including genetic engineering methods.

The mixtures according to the invention, or the herbicidal compositions comprising them, can be employed, for example, in the form of directly sprayable aqueous solutions, powders, suspensions, also highly-concentrated aqueous, oily or other suspensions or dispersions, emulsions, oil dispersions, pastes, dusts, materials for spreading or granules, by means of spraying, atomizing, dusting, spreading or pouring.

The use forms depend on the intended purposes; in any case, they should guarantee the finest possible distribution of the active ingredients according to the invention.

Suitable inert additives (auxiliaries) are mineral oil fractions of medium to high boiling point such as kerosene and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, allylated benzenes and their derivatives, alcohols such as methanol, ethanol, propanol, butanol and cyclohexanol, ketones such as cyclohexanone, strongly polar solvents, such as N-methylpyrrolidone and water.

Aqueous use forms can be prepared from emulsion concentrates, suspensions, pastes, wettable powders or water-dispersible granules by adding water. To prepare emulsions, pastes or oil dispersions, the substances, as such or dissolved in an oil or solvent, can be homogenized in water by means of wetting agent, tackifier, dispersant or emulsifier. However, it is also possible to prepare concentrates composed of active substance, wetting agent, tackifier, dispersant or emulsifier and, if appropriate, solvent or oil, and these concentrates are suitable for dilution with water.

Suitable surfactants are the alkali metal, alkaline earth metal and ammonium salts of aromatic sulfonic acids, e.g. ligno-, phenol-, naphthalene- and dibutyinaphthalenesulfonic acid, and of fatty acids, of alkyl- and alkylaryl sulfonates, of alkyl sulfates, lauryl ether sulfates and fatty alcohol sulfates, and salts of sulfated hexa-, hepta- and octadecanols, and of fatty alcohol glycol ether, condensates of sulfonated naphthalene and its derivatives with formaldehyde, condensates of naphthalene, or of the naphthalenesulfonic acids, with phenol and formaldehyde, polyoxyethylene octylphenyl ether, ethoxylated isooctyl-, octyl- or nonylphenol, alkylphenyl and tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfte waste liquors or methylcellulose.

Powders, materials for spreading and dusts can be prepared by mixing or concomitantly grinding the synergistic herbicidal mixture or the individual active ingredients with a solid carrier.

Granules, e.g. coated granules, impregnated granules and homogeneous granules, can be prepared by binding the active ingredients to solid carriers. Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic material, fertilizers such as ammonium sulfate, ammonium phosphate, ammonium nitrate, ureas and products of vegetable origin such as cereal meal, tree bark meal, wood meal and nutshell meal, cellulose powders or other solid carriers.

The concentrations of the mixtures according to the invention in the ready-to-use products can be varied within wide ranges. In general, the formulations comprise from 0.01 to 95% by weight, preferably 0.5 to 90% by weight, of the mixture according to the invention.

The components A) and B) and, if desired, C) can be formulated jointly, but also separately, and/or applied to the plants, their environment and/or seeds jointly or separately. It is preferable to apply the active ingredients simultaneously. However, it is also possible to apply them separately.

Moreover, it may be advantageous to apply the herbicidal compositions and synergistic herbicidal mixtures according to the invention, jointly or separately, with additional other crop protection agents, for example with pesticides or agents for controlling phytopathogenic fungi or bacteria. Also of interest is the miscibility with mineral salt solutions which are employed for treating nutritional and trace element deficiencies. Non-phytotoxic oils and oil concentrates can also be added.

The mixtures according to the invention and the herbicidal compositions can be applied pre- or post-emergence. If the active ingredients are less well tolerated by certain crop plants, application techniques may be used in which the herbicidal compositions are sprayed, with the aid of the spray apparatus, in such a way that they come into as little contact, if any, with the leaves of the sensitive crop plants while reaching the leaves of undesirable plants which grow underneath, or the bare soil (post-directed, lay-by).

In the case of a post-emergence treatment of the plants, the herbicidal mixtures or compositions according to the invention are preferably applied by foliar application. Application may be effected, for example, by usual spraying techniques with water as the carrier, using amounts of spray mixture of approx. 100 to 1000 I/ha. The mixtures or compositions may also be applied by the so-called “low-volume” and “ultra-low-volume” methods, or in the form of so-called granules.

As a rule, the synergistic herbicidal mixtures comprise components A), B) and, if desired, C) in such weight ratios that the synergistic effect takes place.

The ratios of component A) and B) in the mixture preferably range from 1:0.001 to 1:500, preferably from 1:0.01 to 1:100, particularly preferably from 1:0.1 to 1:50. The ratios of components A) and C) in the mixture preferably range from 1:0.002 to 1:800, preferably from 1:0.003 to 1:160, particularly preferably from 1:0.02 to 1:160.

The rate of application of pure synergistic herbicidal mixture, i.e. without formulation auxiliaries, amounts to 0.1 to 5000 g/ha, preferably 2 to 2000 g/ha, in particular 8 to 1500 g/ha, of active substance (a.s.), depending on the intended aim, the season, the target plants and growth stage.

The rate of application of the compound of the formula I is 0.1 to 100 g/ha, as a rule 1 to 50 g/ha, preferably 5 to 30 g/ha, of active substance (a.s.).

The preferred rate of application of component B) is 0.1 to 2000 g/ha, as a rule 1 to 1000 g/ha, preferably 5 to 500 g/ha, of active substance (a.s.)

The preferred application rate of the active ingredients of the component B) are compiled in Table 1.

The preferred application rate of the active ingredients of the optional component C) are compiled in Table 2.

TABLE 1

| | Rate of application |
|---|---|
| Active ingredient B | (g/ha) |
| cycloxydim | 100-400 |
| tepraloxydim | 50-200 |
| flamprop-methyl | 50-200 |
| imazapyr | 30-400 |
| imazapic | 50-800 |
| Metosulam | 1-60 |
| Halosulfuron-methyl | 5-120 |
| Rimsulfuron | 5-120 |
| Mesosulfuron | 5-30 |
| Iodosulfuron | 0.1-20 |
| Fluthiamide | 250-2000 |
| picloram | 25-750 |
| Diflufenzopyr | 15-100 |
| Sulfosate | 360-1080 |
| Dimethenamid | 60-2000 |
| S-dimethenamid | 60-2000 |
| Metazachlor | 250-4000 |
| Triallate | 1000-5000 |
| Fluroglycofen-ethyl | 5-100 |
| Butafenacil | 5-300 |
| Pyridate | 250-1500 |
| Paraquat-dichloride | 100-800 |
| Diuron | 250-1600 |
| Isoprotoron | 250-1600 |
| Atrazine | 250-4000 |
| Simazine | 250-4000 |
| 2,4-DB | 75-800 |
| Quinclorac | 25-600 |
| pivalicacid-[8-(2,6-diethyl-4- | 20-200 |
| methylphenyl)-1,2,4,5-tetrahydro- | |
| 7-oxo-7H-pyrazolo[1,2- | |
| d][1,4,5]oxadiazepin-9-yl]ester | |

TABLE 2

| | Rate of application |
|---|---|
| Active ingredient C | (g/ha) |
| Dichlormid | 200-600 |
| Benoxacor | 10-200 |
| LAB 145138 | 50-500 |
| MG-191 | 200-1000 |
| MON-13900 | 10-200 |
| Naphtalicacidanhydride | 300-1000 |
| Fenchlorim | 20-500 |
| Fenchlorazol | 5-100 |
| Mefenpyr-diethyl | 5-100 |
| Isoxadifen-ethyl | 1-50 |
| Cloquintocet-mexyl | 1-50 |

### USE EXAMPLES

The mixtures according to the invention were applied pre- or post-emergence (foliar treatment). The herbicidal compounds of component B and, if desired, of component C were applied in the formulation in which they are present as commercially available product.

The herbicidally active compounds of components A), B) and, if desired, C) were applied in succession or jointly, in the latter case in some cases as a tank mix and in some cases as a readymix, in the form of emulsions, aqueous solutions or suspensions, the vehicle being water (300-400 I/ha). In the case of the field trials, application was effected with the aid of a mobile plot sprayer.

The test period extended over 3 to 8 weeks, and the stands were also observed at later points in time.

Damage by the herbicidal compositions was evaluated with reference to a scale of 0% to 100% in comparison with untreated control plots. 0 means no damage and 100 means complete destruction of the plants.

The following examples will demonstrate the action of the herbicidal compositions which can be used according to the invention, without excluding the possibility of other uses.

In these examples, the value E at which only an additive effect of the individual active ingredients is to be expected was calculated by the method of S. R. Colby (Calculating synergistic and antagonistic responses of herbicide combinations, Weeds 15, 20 pp (1967)).

This was done using the formula

$$E = X + Y - \frac{XY}{100}$$

where
X=Percentage of the herbicidal action of component A) at an application rate of a;
Y=Percentage of the herbicidal action of component B) at an application rate of b;
E=expected herbicidal action of component A)+B) at rates of application a+b (in %).

If the value observed exceeds the value E calculated in accordance with Colby's formula, then synergism is present.

The herbicidal mixtures according to the invention exert a greater herbicidal action than would have been expected according to Colby on the basis of the observed effects of the individual components when used alone.

1. A synergistic herbicidal mixture comprising
A) [N-(5,7-Dimethoxy[1,2,4]triazolo[1,5-a]pyrimidin-2-yl)-2-methoxy-4-(trifluoromethyl)]-3-pyridinesulfonamid I 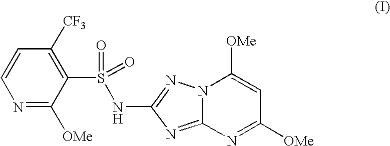
or its environmentally compatible salts;
and
B) at least one herbicidal compound selected from the group consisting of alloxydim, clethodim, cloproxydim, cycloxydim, butroxydim, clefoxydim, tepraloxydim, cyhalofop-butyl, fenthiapropethyl, fluazifop-P-butyl, isoxapyrifop, propaquizafop, quizalofop-ethyl, quizalofop-P-ethyl, quizalofoptefuryl, flamprop-methyl, flamprop-isopropyl, imazapyr, imazapic, pyrithiobacacid, pyrithiobac-sodium, bispyribac-sodium, KIH-6127, pyribenzoxym, metosulam, azimsulfuron, bensulfuron-methyl, chlorsulfuron, cinosulfuron, cyclosulfamuron,ethoxysulfuron, flazasulfuron, halosulfuron-methyl, imazosulfuron, primisulfuron-methyl, pyrazosulfuron-ethyl, rimsulfuron, sulfometuron-methyl, triflusulfuron-methyl, mesosulfuron, iodosulfuron, allidochlor (CDAA), benzoylprop-ethyl, bromobutide, chlorthiamid, diphenamid, etobenzanid (benzchlomet), fluthiamide, fosamin, monalide, picloram, benazolin, naptalame, diflufenzopyr, fluorochloridone, fluridone, flurtamone, norflurazon, amitrol, sulfosate, bilanafos (bialaphos), anilofos, mefenacet, dimethenamid, S-dimethen-amid, alachlor, butachlor, butenachlor, diethatyl-ethyl, dimethachlor, metazachlor, pretilachlor, propachlor, prynachlor, terbuchlor, thenylchlor, xylachlor, butylate, cycloate, di-allate, dimepiperate, EPTC, esprocarb, molinate, pebulate, prosulfocarb, thiobencarb (benthiocarb), tri-allate, vernolate, benfuresate, perfluidone, asulam, carbetamid, chlorpropham, orbencarb, pronamid (propyzamid), propham, tiocarbazil, butralin, dinitramin, ethalfluralin, fluchloralin, oryzalin, prodiamine, dithiopyr thiazopyr, butamifos, chlorthal-dimethyl (DCPA), maleic hydrazide, aclonifen, bifenox, chlornitrofen (CNP), ethoxyfen, fluorodifen, fluoroglycofen-ethyl, fomesafen, furyloxyfen, nitrofen, nitrofluorfen, oxyfluorfen, oxadiargyl, oxadiazon, azafenidin, butafenacil, flumiclorac-pentyl, flumioxazin, flumipropyn, flupropacil, fluthiacet-methyl, sulfentrazone, thidiazimin, ET-751, JV 485, nipyraclofen, propanil, pyridate, pyridafol, bromofenoxim, dinoseb, dinoseb-acetate, dinoterb,DNOC, cyperquatchloride, difenzoquat-methylsulfate, diquat, paraquat-dichloride, chlorbromuron, chlorotoluron, difenoxuron, dimefuron, diuron, ethidimuron, fenuron, isoproturon, isouron, methabenzthiazuron, methazole, metobenzuron, metoxuron, neburon, siduron, tebuthiuron, ioxynil, chloridazon, ametryn, atrazine, cyanazine, desmetryn, dimethamethryn, hexazinone, prometon, prometryn, propazine, simazine, simetryn, terbumeton, terbutryn, terbutylazine, trietazine, metamitron, bromacil, lenacil, terbacil, desmedipham, phenmedipham, tridiphane, 2,4-DB, clomeprop, MCPB, triclopyr, chloramben, quinclorac dichlobenil, dalapon, ethofumesate, chlorfenac (fenac), aziprotryn, barban, bensulide, benzthiazuron, benzo-fluor, buminafos, buthidazole, buturon, cafenstrole, chlorbufam, chlorfenpropmethyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid,trimeturon, 8-(2,6-Diethyl-4-methylphenyl)-1,2,4,5-tetrahydro-9-hydroxy-7H-pyrazolo[1,2-d][1,4,5]oxadiazepin-7-one, pivalicacid-[8-(2,6-diethyl-4-methylphenyl)-1,2,4,5-tetrahydro-7-oxo-7H-pyrazolo[1,2-d][1,4,5]oxadiazepin-9-yl]ester and an environmentally compatible salts of said herbicidal compound:
and, if desired,
C) at least one safener compound selected from the group consisting of Dichlormid, Benoxacor, LAB-145138, MG-191, MON-13900, Cyometrinil, Oxabetrinil, Fluxofenim, Flurazole, Naphtalicacidanhydride, Fenchlorim, Fenchlorazol, Mefenpyr and its environmentally compatible salts and esters, Isoxadifen and its environmentally compatible salts and esters, Cloquintocet and its environmentally compatible salts, esters and hydrates, 1-Ethyl-4-hydroxy-3-(1H-tetrazol-5-yl)-1H-quinolin-2-one, 4-Carboxymethyl-chroman-4-carboxylic acid, N-(2-Methoxy-benzoyl)-4-(3-methyl-ureido)-benzenesulfonamide, and (3-Oxo-isothiochroman-4-ylidenemethoxy)-acetic acid methyl ester.

2. A synergistic herbicidal mixture as claimed in claim 1 in which B) and C) are as follows
B) at least one herbicidal compound selected from the group consisting of cycloxydim, tepraloxydim, cyhalofop-butyl, fluazifop-P-butyl, flamprop-methyl, flamprop-isopropyl, imazapyr, imazapic, pyrithiobac-sodium, bispyribacsodium, metosulam, bensulfuron-methyl, chlorsulfuron, cinosulfuron, cyclosulfamuron, ethoxysulfuron, halosulfu ron-methyl, pyrazosulfuron-ethyl, rimsulfuron, sulfometuron-methyl, triflusulfuron-methyl, mesosulfuron, iodosulfuron, bromobutide, chlorthiamid, picloram, diflufenzopyr, fluorochloridone, sulfosate, mefenacet, dimethenamid, S-dimethenamid, alachlor, butachlor, metazachlor, pretilachlor, tri-allate, butralin, oryzalin, dithiopyr, thiazopyr, aclonifen, bifenox, fluoroglycofen-ethyl, oxadiargyl, oxadiazon, azafenidin, butafenacil, flumiclorac-pentyl, flumioxazin, fluthiacetmethyl, sulfentrazone, thidiazimin, ET-751, JV 485, nipyraclofen, propanil, pyridate, pyridafol, paraquat-dichloride, chlorbromuron, chlorotoluron, diuron, isoproturon, siduron, ioxynil, chloridazon, ametryn, atrazine, cyanazine, prometryn, simazine, terbutylazine, metamitron, bromacil, 2,4-DB, clomeprop, MCPB, triclopyr, chloramben, quinclorac dichlobenil, cafenstrole, cinmethylin, flucabazone, flupoxam, monuron, oxaciclomefone, triaziflam, triazofenamid,trimeturon, 8-(2,6-Diethyl-4-methylphenyl)-1,2,4,5-tetrahydro-9-hydroxy-7H-pyrazolo[1,2-d][1,4,5]oxadiazepin-7-one, pivalicacid-[8-(2,6-diethyl-4-methylphenyl)-1,2,4,5-tetrahydro-7-oxo-7H-pyrazolo[1,2-d][1,4,5]oxadiazepin-9-yl]ester
and an environmentally compatible salts of said herbicidal compound;
C) at least one saftener compound selected from the group consisting of the Dichlormid, Benoxacor, LAB-145138, MG-191, MON-13900, Naphtalicacidanhydride, Fenchlorim, Fenchlorazol, Mefenpyr and its environmentally compatible esters, Isoxadifen and its environmentally compatible esters, Cloquintocet and its environmentally compatible esters and hydrates.

3. A synergistic herbicidal mixture as claimed in claim 1 in which B) and C) are as follows:
B) at least one herbicidal compound selected from the group consisting of cycloxydim, tepraloxydim, flamprop-methyl, imazapyr, imazapic, metosulam, bensulfuron-methyl, chlorsulfuron, cyclosulfamuron, ethoxysulfuron, halosulfuron-methyl, rimsulfuron, sulfometuron-methyl, mesosulfuron, iodosulfuron, picloram, diflufenzopyr, fluorochloridone, sulfosate, dimethenamid, S-dimethenamid, alachlor, butachlor, metazachlor, pretilachlor, tri-allate, aclonifen, bifenox, fluoroglycofen-ethyl, butafenacil, propanil, pyridate, paraquat-dichloride, chlorbromuron, chlortoluron, diuron, isoproturon, atrazine, cyanazine, simazine, 2,4-DB, quinclorac, dichlobenil, cinmethylin, flucabazone, flupoxam, 8-(2,6-Diethyl-4-methylphenyl)-1,2,4,5-tetrahydro-9-hydroxy-7H-pyrazolo[1,2-d][1,4,5]oxadiazepin-7-one, pivalicacid-[8-(2,6-diethyl-4-methylphenyl)-1,2,4,5-tetrahydro-7-oxo-7H-pyrazolo[1,2-d][1,4,5]oxadiazepin-9-yl]ester
and an environmentally compatible salts of said herbicidal compound;
C) at least one safener compound selected from the group consisting of Dichlormid, Benoxacor, LAB-145138, MG-191, MON-13900, Naphtalicacidanhydride, Fenchlorim, Fenchlorazol, Mefenpyr and its environmentally compatible esters, Isoxadifen and its environmentally compatible esters, Cloquintocet and its environmentally compatible esters and hydrates.

4. A synergistic herbicidal mixture as claimed in claim in which B) and C) are as follows:
B) at least one herbicidal compound selected from the group consisting of cycloxydim, tepraloxydim, flamprop-methyl, imazapyr, imazapic, metosulam, mesosulfuron, iodosulfuron, diflufenzopyr, sulfosate, dimethenamid, S-dimethenamid, metazachlor, tri-allate, paraquat-dichloride, isoproturon, atrazine, cyanazine, 2,4-DB, quinclorac
and an environmentally compatible salt, of said herbicidal compound;
C) at least one safener compound selected from the group consisting of Benoxacor, Mefenpyr and its environmentally compatible esters, Isoxadifen and its environmentally compatible esters, Cloquintocet and its environmentally compatible esters and hydrates.

5. A synergistic herbicidal mixture as claimed in claim 1 in which B) and C) are as follows:
B) at least one herbicidal compound selected from the group consisting of imazapyr and imazapic;
C) Cloquintocet or its environmentally compatible esters and hydrates.

6. A synergistic herbicidal mixture as claimed in claim 1 in which B) and C) are as follows:
B) iodosulfuron,
C) at least one safener compound selected from the group consisting of Isoxadifen and its environmentally compatible esters, and Cloquintocet and its environmentally compatible esters and hydrates.

7. Synergistic herbicidal mixture as claimed in claim 1, wherein component A) and B) are present in a weight ratio of 1:0.001 to 1:500.

8. Synergistic herbicidal mixture as claimed in claim 1, wherein component A) and component C) are present in a weight ratio of 1:0.002 to 1:800.

9. A herbicidal composition comprising a herbicidally active amount of a synergistic herbicidal mixture as claimed in claim 1, at least one inert liquid and/or solid carrier and, if desired, at least one surfactant.

10. A process for the preparation of a herbicidal composition as claimed in claim 9, comprising mixing component A), component B), if desired, component C), at least one inert liquid and/or solid carrier and, if appropriate, a surfactant.

11. A method of controlling undesired vegetation, which comprises simultaneously or in succession applying to undesired, plants their environment and/or their seeds a synergistic herbicidal mixture as claimed in claim 1 before, during and/or after the emergence of the undesired plants.

12. A method of controlling undesired vegetation as claimed in claim 11, wherein the leaves of the crop plants and of the undesired plants are treated.

13. A method for controlling undesired vegetation comprising simultaneously or successively applying to undesired plants, their habitation their seeds
A) [N-(5,7-Dimethoxy[1,2,4]triazolo[1,5-a]pyrimidin-2-yl)-2-methoxy-4-(trifluoromethyl)]-3-pyridinesulfonamid I 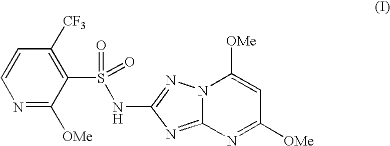
or its environmentally compatible salts;
and
B) at least one herbicidal compound selected from the group consisting of alloxydim, clethodim, cloproxydim, cycloxydim, butroxydim, clefoxydim, tepraloxydim, cyhalofop-butyl, fenthiapropethyl, fluazifop-P-butyl, isoxapyrifop, propaquizafop, quizalofop-ethyl, quizalofop-P-ethyl, quizalofoptefuryl, flamprop-methyl, flamprop-isopropyl, imazapyr, imazapic, pyrithiobacacid, pyrithiobac-sodium, bispyribac-sodium, KIH-6127, pyribenzoxym, metosulam, azimsulfuron, bensulfuron-methyl, chlorsulfuron, cinosulfuron, cyclosulfamuron,ethoxysulfuron, flazasulfuron, halosulfuron-methyl, imazosulfuron, primisulfuron-methyl, pyrazosulfuron-ethyl, rimsulfuron, sulfometuron-methyl, triflusulfuron-methyl, mesosulfuron, iodosulfuron, allidochlor (CDAA), benzoylprop-ethyl, bromobutide, chlorthiamid, diphenamid, etobenzanid (benzchlomet), fluthiamide, fosamin, monalide, picloram, benazolin, naptalame, diflufenzopyr, fluorochloridone, fluridone, flurtamone, norflurazon, amitrol, sulfosate, bilanafos (bialaphos), anilofos, mefenacet, dimethenamid, S-dimethen-amid, alachlor, butachlor, butenachlor, diethatyl-ethyl, dimethachlor, metazachlor, pretilachlor, propachlor, prynachlor, terbuchlor, thenylchlor, xylachlor, butylate, cycloate, di-allate, dimepiperate, EPTC, esprocarb, molinate, pebulate, prosulfocarb, thiobencarb (benthiocarb), tri-allate, vernolate, benfuresate, perfluidone, asulam, carbetamid, chlorpropham, orbencarb, pronamid (propyzamid), propham, tiocarbazil, butralin, dinitramin, ethalfluralin, fluchloralin, oryzalin, prodiamine, dithiopyr thiazopyr, butamifos, chlorthal-dimethyl (DCPA), maleic hydrazide, aclonifen, bifenox, chlornitrofen (CNP), ethoxyfen, fluorodifen, fluoroglycofen-ethyl, fomesafen, furyloxyfen, nitrofen, nitrofluorfen, oxyfluorfen, oxadiargyl, oxadiazon, azafenidin, butafenacil, flumiclorac-pentyl, flumioxazin, flumipropyn, flupropacil, fluthiacet-methyl, sulfentrazone, thidiazimin, ET-751, JV 485, nipyraclofen, propanil, pyridate, pyridafol, bromofenoxim, dinoseb, dinoseb-acetate, dinoterb,DNOC, cyperquatchloride, difenzoquat-methylsulfate, diquat, paraquat-dichloride, chlorbromuron, chlorotoluron, difenoxuron, dimefuron, diuron, ethidimuron, fenuron, isoproturon, isouron, methabenzthiazuron, methazole, metobenzuron, metoxuron, neburon, siduron, tebuthiuron, ioxynil, chloridazon, ametryn, atrazine, cyanazine, desmetryn, dimethamethryn, hexazinone, prometon, prometryn, propazine, simazine, simetryn, terbumeton, terbutryn, terbutylazine, trietazine, metamitron, bromacil, lenacil, terbacil, desmedipham, phenmedipham, tridiphane, 2,4-DB, clomeprop, MCPB, triclopyr, chloramben, quinclorac dichlobenil, dalapon, ethofumesate, chlorfenac (fenac), aziprotryn, barban, bensulide, benzthiazuron, benzo-fluor, buminafos, buthidazole, buturon, cafenstrole, chlorbufam, chlorfenpropmethyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid,trimeturon, 8-(2,6-Diethyl-4-methylphenyl)-1,2,4,5-tetrahydro-9-hydroxy-7H-pyrazolo[1,2-d][1,4,5]oxadiazepin-7-one, pivalicacid-[8-(2,6-diethyl-4-methylphenyl)-1,2,4,5-tetrahydro-7-oxo-7H-pyrazolo[1,2-d][1,4,5]oxadiazepin-9-yl]ester
and an environmentally compatible salt of said herbicidal compound;
and, if desired,
C) at least one safener compound selected from the group consisting of Dichlormid, Benoxacor, LAB-145138, MG-191, MON-13900, Cyometrinil, Oxabetrinil, Fluxofenim, Flurazole, Naphtalicacidanhydride, Fenchlorim, Fenchlorazol, Mefenpyr and its environmentally compatible salts and esters, Isoxadifen and its environmentally compatible salts and esters, Cloquintocet and its environmentally compatible salts, esters and hydrates, 1-Ethyl-4-hydroxy-3-(1H-tetrazol-5-yl)-1H-quinolin-2-one, 4-Carboxymethyl-chroman-4-carboxylic acid, N-(2-Methoxy-benzoyl)-4-(3-methyl-ureido)-benzenesulfonamide, and (3-Oxo-isothiochroman-4-ylidenemethoxy)-acetic acid methyl ester.
